(19) United States
(12) Patent Application Publication
(10) Pub. No.: US 2006/0112403 A1
(43) Pub. Date: May 25, 2006

(54) Disk apparatus and electronic apparatus including same

(75) Inventor: Kazuhiro Watanabe, Echizen-shi (JP)

Correspondence Address: RED SMITH LLP, Suite 1400, 3110 Fairview Park Drive, Falls Church, VA, 22042, US

(73) Assignee: Orion Electric Company Ltd.

(21) Appl. No.: 11/281,611

(22) Filed: Nov. 18, 2005

(30) Foreign Application Priority Data
Nov. 25, 2004 (JP) 2004-341149

(51) Int. Cl. G11B 17/04

(52) U.S. Cl. 720/619

(57) ABSTRACT

A main body frame 2 is provided with an opening member 4 in which an opening 3 is formed, the opening being inclined during a disk D reproducing state in which the disk D is inserted in the main body frame 2 to prevent so as not to erroneously insert a different new disk into the main body frame 2. It is thereby possible to prevent misinsertion of the different new disk into the main body frame 2, visually recognize the inclined opening member 4, and easily confirm whether or not the disk D is inserted in the main body frame 2.

### BACKGROUND OF THE INVENTION

1. Field of the Invention

The present invention relates to a disk apparatus that can directly insert or discharge a disk into or from an interior of the apparatus and an electronic apparatus that includes the disk apparatus. More specifically, the present invention relates to a disk apparatus that can prevent misinsertion of a different new disk into an interior of the apparatus while a disk is already inserted in the interior thereof and an electronic apparatus that includes the disk apparatus.

2. Description of the Related Art

Conventionally, an electronic apparatus, e.g., a television receiver, including therein a disk apparatus into an interior of which a flat disk such as a CD-R is inserted and which can record and reproduce data such as voice data or video data has been employed. In recent years, in view of reducing the number of components, a so-called slot-in type disk apparatus into which a disk is directly inserted differently from a tray type disk apparatus configured so that a disk is mounted on a tray and so that the disk is inserted into a predetermined position of the disk apparatus has been popular.

However, the slot-in type disk apparatus has the following disadvantages. The disk is inserted into the disk apparatus through an opening provided in a front surface of the disk apparatus and having a width slightly larger than a thickness of the disk. Due to this, once the disk is arranged at a predetermined position within the disk apparatus, a user cannot confirm afterwards, for example, whether or not the disk is inserted unless the user operates an eject button or the like for discharging the disk. The operation is quite cumbersome. In addition, in case of the slot-in type disk apparatus, whether a disk is arranged within the disk apparatus or not, it is normally possible to always insert a part of a different new disk from the opening. For this reason, when a disk is already arranged within the apparatus, if a different new disk is to be inserted into the disk apparatus, the different new disk may possibly contact with a member within the disk apparatus or with the previously inserted disk to thereby damage a surface of the disk. To solve these disadvantages, a disk apparatus including a misinsertion prevention member that closes an insertion/discharge port for inserting and discharging the disk is disclosed in Japanese Patent Application Laid-Open No. 2001-331999. A disk protection apparatus for preventing double insertion of the disk is disclosed in Japanese Utility Model Application Laid-Open No. 6-11141.

### SUMMARY OF THE INVENTION

The present invention has been achieved to solve the conventional disadvantages. It is an object of the present invention to provide a disk apparatus capable of preventing misinsertion of a disk, and easily and visually recognizing insertion of the disk in the disk apparatus, and an electronic apparatus including the disk apparatus.

A disk apparatus according to a first aspect of the present invention includes: a main body frame into which a disk is inserted; an opening member in which an opening for inserting the disk into the main body frame is formed; and a rack loading member moved forward or backward within the main body frame, wherein a convex portion formed on the opening member is inserted in a guide groove formed in the rack loading member, the opening member is rotatably and pivotally supported by the main body frame, in a disk reproducing state in which the disk is inserted in the main body frame, the rack loading member is moved backward, the convex portion inserted in the guide groove is slidably moved along the guide groove to follow a backward movement of the rack loading member, and the opening member rotated and inclined to follow a slidable movement of the convex portion is assembled in a front surface of the disk apparatus.

With the constitution of the first aspect of the present invention, in the disk reproducing state in which a disk is inserted in the main body frame, the opening is inclined so as not to erroneously insert a different new disk into the main body frame through the opening. It is, therefore, possible to prevent misinsertion of the disk into the main body frame. In addition, the opening member assembled in the front surface of the disk apparatus is inclined in the disk reproducing state in which the disk is inserted in the main body frame. A user or the like can, therefore, visually recognize this inclined opening member and easily confirm whether or not the disk is inserted in the main body frame.

An electronic apparatus including the disk apparatus according to a second aspect of the present invention includes, in the disk apparatus of the first aspect, a display unit that displays an image based on output data output when information is reproduced from the disk.

With the constitution of the second aspect of the present invention, the disk apparatus that reproduces information from the disk is included in the electronic apparatus, e.g., a television receiver, including a display unit. By including the disk apparatus in the normally popular electronic apparatus such as the television receiver, the practicability of the electronic apparatus is enhanced.

The disk apparatus according to the first aspect of the present invention includes: a main body frame into which a disk is inserted; an opening member in which an opening for inserting the disk into the main body frame is formed; and a rack loading member moved forward or backward within the main body frame, wherein a convex portion formed on the opening member is inserted in a guide groove formed in the rack loading member, the opening member is rotatably and pivotally supported by the main body frame, in a disk reproducing state in which the disk is inserted in the main body frame, the rack loading member is moved backward, the convex portion inserted in the guide groove is slidably moved along the guide groove to follow a backward movement of the rack loading member, and the opening member rotated and inclined to follow a slidable movement of the convex portion is assembled in a front surface of the disk apparatus. In addition, it is possible to prevent the disk from being damaged by misinsertion of a different disk, to visually recognize that the opening member is inclined, and to easily confirm that a disk is inserted in the main body frame at a glance.

The electronic apparatus including the disk apparatus according to the second aspect of the present invention includes, in the disk apparatus of the first aspect, a display unit that displays an image based on output data output when information is reproduced from the disk. Thus, by including the disk apparatus in the normally popular electronic apparatus such as the television receiver and a computer monitor, an electronic apparatus with an excellent practicability can be provided.

### BRIEF DESCRIPTION OF THE DRAWINGS

FIG. 1 is a perspective view that depicts a disk apparatus according to one embodiment of the present invention;

FIG. 2 is a perspective view that depicts a state in which a disk has been inserted in the disk apparatus according to the embodiment;

FIG. 3 is a cross-sectional view that depicts a schematic configuration of the disk apparatus according to the embodiment;

FIG. 4 is a front view of the disk apparatus according to the embodiment;

FIG. 5 is a schematic cross-sectional view that depicts a state in which the disk is to be inserted into the disk apparatus according to the embodiment;

FIG. 6 is a schematic cross-sectional view that depicts a state in which the disk is inserted in the disk apparatus according to the embodiment, and in which an opening member is inclined; and

FIGS. 7A and 7B are explanatory views that show operations when the disk is inserted into the disk apparatus according to the embodiment, wherein FIG. 7A is an explanatory view for an operation when the disk is inserted into the disk apparatus and FIG. 7B is an explanatory view that depicts a state in which the disk has been inserted in the disk apparatus.

### DESCRIPTION OF THE PREFERRED EMBODIMENTS

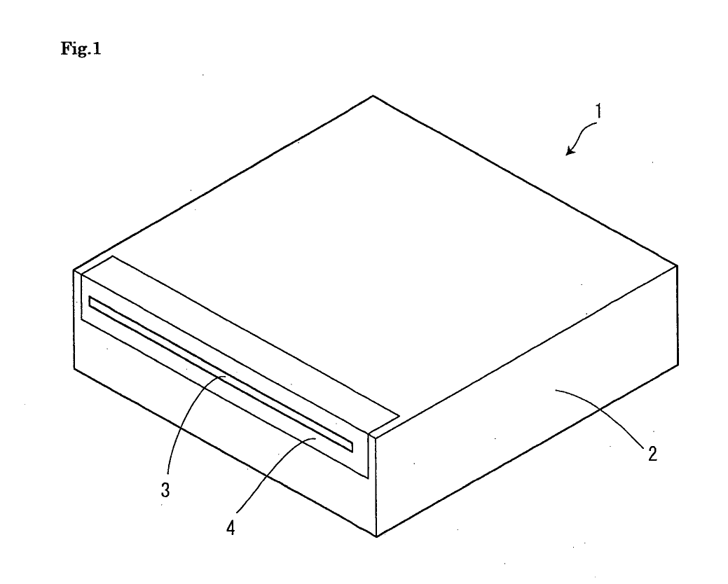

A most preferred embodiment of the present invention will be described hereinafter with reference to FIGS. 1 to 7A and 7B.

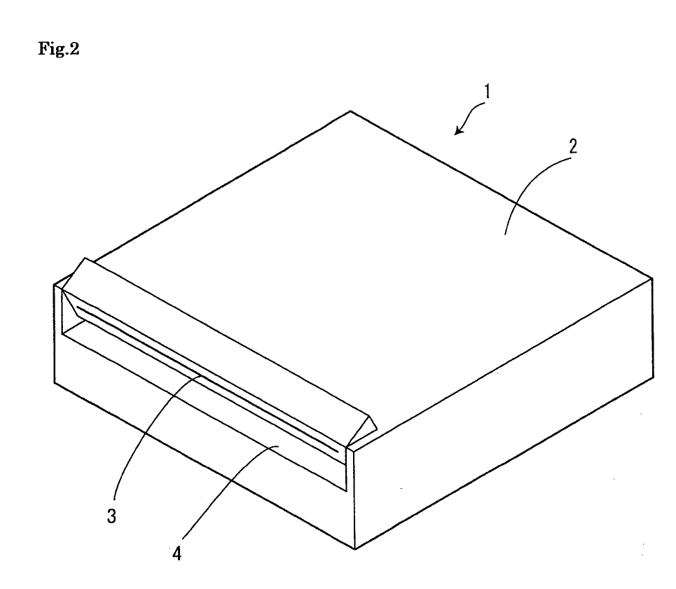

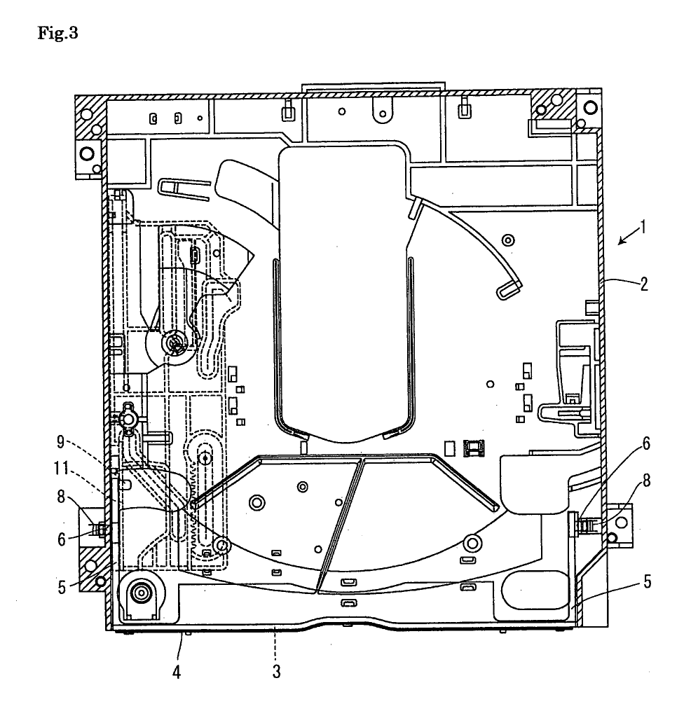

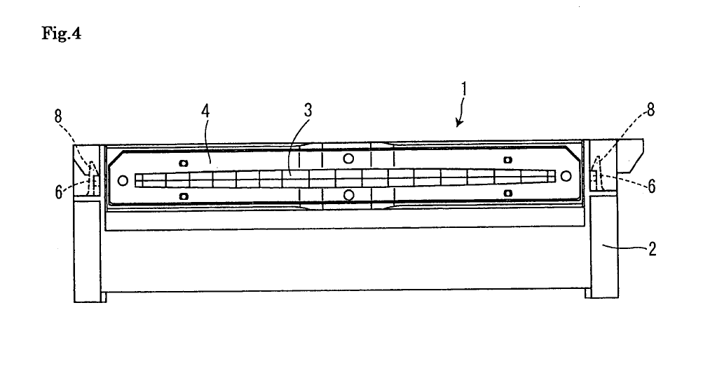

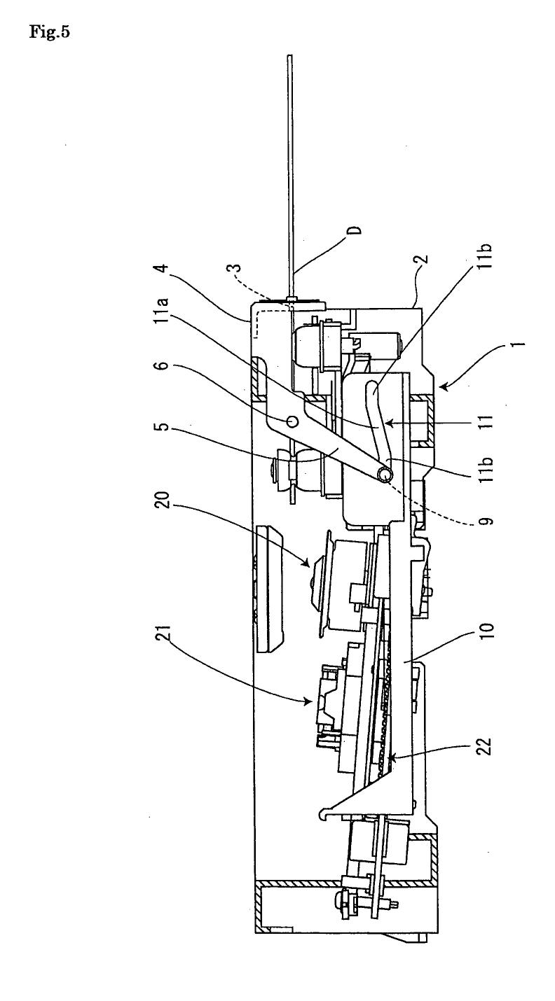

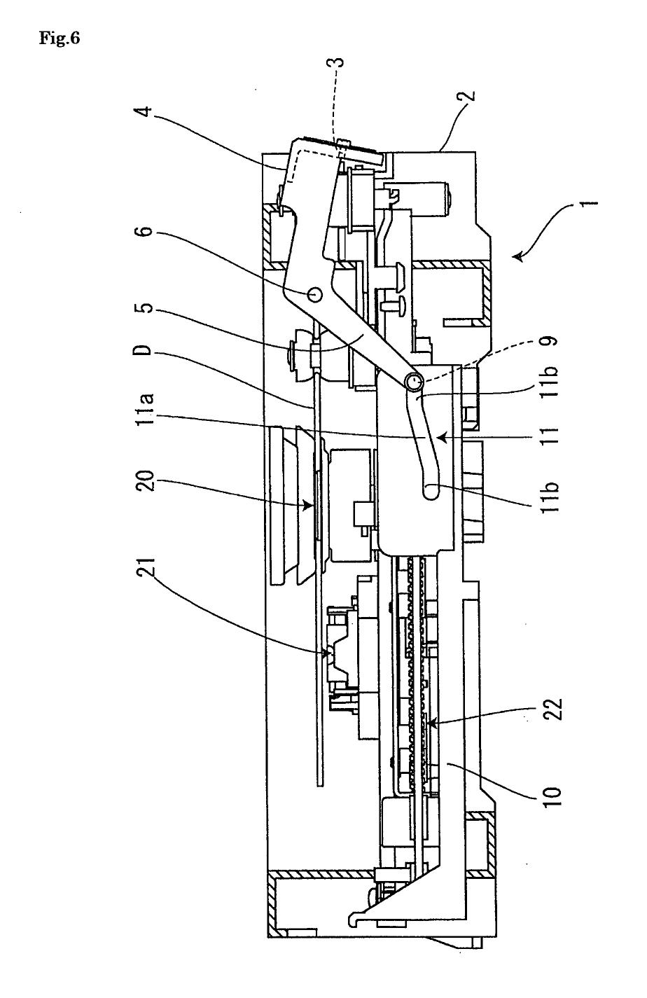

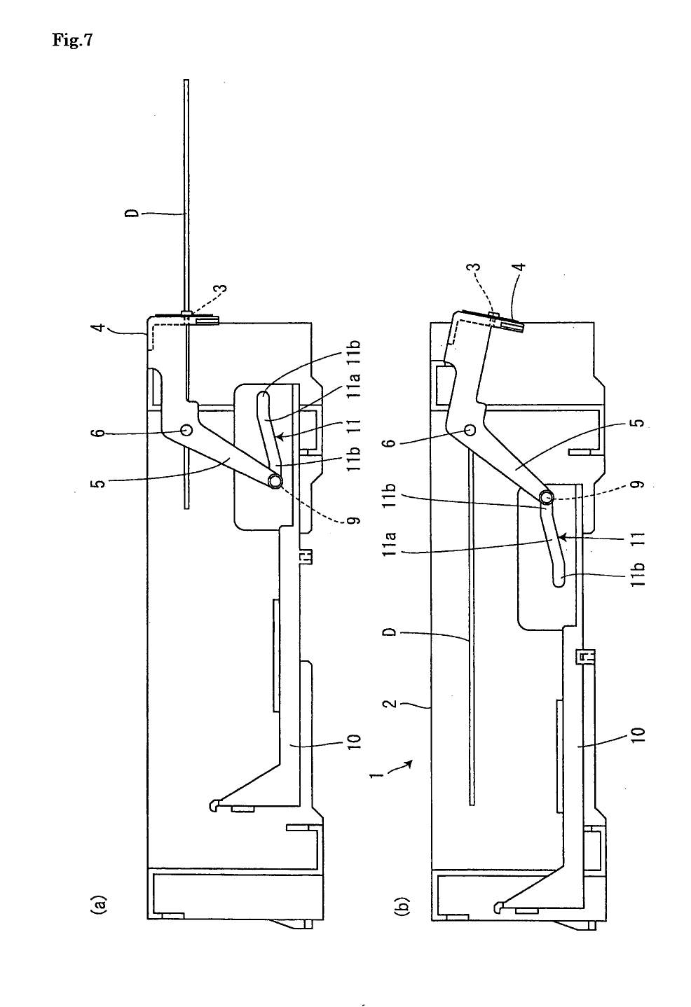

FIG. 1 is a perspective view of a disk apparatus according to one embodiment of the present invention. FIG. 2 is a perspective view that depicts a state in which a disk has been inserted in the disk apparatus. FIG. 3 is a cross-sectional view that depicts a schematic configuration of the disk apparatus. FIG. 4 is a front view of the disk apparatus according to the embodiment. FIG. 5 is a schematic cross-sectional view that depicts a state in which the disk is to be inserted into the disk apparatus. FIG. 6 is a schematic cross-sectional view that depicts a state in which the disk is inserted in the disk apparatus, and in which an opening member is inclined. FIGS. 7A and 7B are explanatory views that show operations when the disk is inserted into the disk apparatus.

An entire form of a disk apparatus 1 is constituted by a generally box-shaped main body frame 2, and a horizontal opening 3 through which a disk is inserted and discharged is formed on a front surface of the main body frame 2. The opening 3 is formed in an opening member 4 attached to the main body frame 2 and constituting a part of an external form of the disk apparatus 1. A support 5 extending rearward from both side ends of this opening member 4 forms a pair of cylindrical bosses 6 protruding outward from this support 5. By causing a concave engagement portion 8 formed on the main body frame 2 to pivotally support the bosses 6, the opening member 4 is assembled to rotate relative to the main body frame 2 with the bosses 6 set as fulcrums.

Further, a guide groove 11 is formed in a rack loading member 10 moved forward and backward within the main body frame 2. A convex portion 9 formed on one end of the support 5 is slidably inserted in the guide groove 11. If a disk D is inserted from a disk insertable state in which the disk D is not entirely inserted in the disk apparatus 1 shown in FIG. 7A, i.e., a state in which the opening 3 is arranged horizontally, into a predetermined position within the main body frame 2 in the disk apparatus 1 so as to reproduce or record data from or in the disk D, for example, the rack loading member 10 is moved backward (a state shown in FIG. 7B) by driving means such as a drive motor, not shown. Namely, from a state in which the disk D is not inserted in the predetermined position within the main body frame 2 shown in FIG. 7A, the convex portion 9 is finally moved to a rear portion along the guide groove 11 to follow a backward movement of the rack loading member 10 (a state shown in FIG. 7B). At this time, the opening member 4 is rotated with the bosses 6 set as fulcrums, and the opening 3 that has been arranged horizontally is inclined. In such a state in which the disk D is inserted in the disk apparatus 1 and information can be reproduced from the disk D, the opening 3 is inclined relative to the main body frame 2. Thanks to this, even if a different flat disk D is to be horizontally inserted into the disk apparatus 1 through this inclined opening 3, the disk comes into contact with an inner wall surface of the main body frame 2 and various other members. It is, therefore, possible to prevent misinsertion of the disk into the disk apparatus 1. Besides, by inclining the opening member 4 in which the opening 3 is formed and which constitutes the external form of the disk apparatus 1, a user or the like can confirm that the disk D is inserted in the disk apparatus 1 at a glance. Therefore, it is possible to not only recognize that the disk D cannot be inserted after taking an initial operation for inserting the disk D into the apparatus 1 as done in a conventional disk reproducing apparatus, but also visually recognize that the opening member 4 is inclined and easily confirm whether or not the disk D is inserted in the main body frame 2 in advance. Due to this, it is possible to avoid contacting a surface of the disk D that is apt to be damaged with various members, devices, or the like within the main body frame 2 and damaging the surface of the disk D, e.g., scratching the surface of the disk D if a different disk D is to be newly inserted into the disk apparatus 1 while the disk D is already inserted in the disk apparatus 1. As shown in FIGS. 7A and 7B, the guide groove 11 is configured by an inclined portion 11a and parallel portions 11b extending horizontally from both ends of this inclined portion 11a, respectively. The convex portion 9 can be smoothly moved along the inclined portion 11a of the guide groove 11 to correspond to a track on which the convex portion 9 is moved in a height direction following rotation of the opening member 4 with the bosses 6 set as fulcrums. It is, therefore, possible to make a vertical gap between the guide groove 11 and the convex portion 9 extremely small, so that the rotation operation of the opening member 4 following forward or backward movement of the rack loading member 10 can be performed smoothly while minimizing a backlash and the like.

Furthermore, the disk apparatus 1 includes, as important constituent elements, a roller, not shown, for inserting or discharging the disk D when a part of the disk D is inserted through the opening 3, a turntable 20 on which the disk D inserted in the main body frame 2 is mounted and turned, a pickup unit 21 for reading information such as data from the disk D turned by the turntable 20 or for writing information to the disk D, a traverse unit 22 assembled with the turntable 20 and the pickup unit 21, and the above-stated rack loading member 10 that tilts the traverse unit 22 and that is moved forward or backward within the main body frame 2.

The disk apparatus 1 according to this embodiment stated so far includes the main body frame 2 into which the disk D is inserted, the opening member 4 in which the opening 3 for horizontally inserting the disk D into this main body frame 2 is formed, and the rack loading member 10 moved forward or backward within the main body frame 2. The convex portion 9 formed on the support 5 of the opening member 4 is inserted in the guide groove 11 formed in the rack loading member 10, and the opening member 4 is rotatably and pivotally supported by the main body frame 2. When the disk D is inserted in the main body frame 2, e.g., in a state in which information can be reproduced or recorded from or in the disk D, the rack loading member 10 is driven to be moved backward of the disk apparatus 1 (left side shown in FIG. 7B) by the driving means such as the drive motor, not shown. The concave portion 9 inserted in the guide groove 11 is slidably moved along the guide groove 11 to follow this backward movement of the rack loading member 10. The opening member 4 rotated and inclined to follow the slidable movement of this convex portion 9 is assembled in the front surface of the disk apparatus 1. By so configuring, while information can be reproduced or recorded from or in the disk D inserted in the main body frame 2, the opening 3 is inclined so as not to erroneously insert a different new disk into the main body frame 2 through the opening 3. The new disk cannot be inserted into the main body frame 2, whereby it is possible to prevent misinsertion of the disk D into the main body frame 2. Besides, the opening member 4 assembled in the front surface of the disk apparatus 1 is inclined in a disk D reproducing state in which the disk D is inserted in the main body frame 2. Due to this, the user or the like can visually recognize that the opening member 4 is inclined and easily confirm whether or not the disk D is inserted in the main body frame 2. Furthermore, although not shown in the drawings, if the disk apparatus 1 is included in an electronic apparatus, e.g., a television receiver or a personal computer monitor, including a display unit that can display an image, the electronic apparatus capable of displaying the image by the display unit based on output data output during reproduction of information from the disk D and excellent in practicability can be provided to the user. In addition, if the disk apparatus 1 is provided so that the opening member 4 is arranged on a front surface, a side surface or the like of a cabinet that constitutes the external form of the electronic apparatus, the opening member 4 can be visually recognized from outside. Besides, while the opening member 4 is inclined, it is possible to easily confirm whether or not the disk D is inserted in the main body frame 2 of the disk apparatus 1.

The embodiment of the present invention has been described so far. However, the present invention is not limited to the embodiment but various changes and modifications can be made to the present invention within the scope of the invention. The electronic apparatus including the disk apparatus according to the present invention can be arbitrarily selected. For example, the disk apparatus 1 can be included in an electronic apparatus such as a videotape recorder besides the electronic apparatus, e.g., the television receiver or the personal computer monitor, including the display unit. In addition, the disk apparatus can be provided as a car stereo in an automobile and the like.

What is claimed is:

1. A disk apparatus comprising:
a main body frame into which a disk is inserted;
an opening member in which an opening for inserting the disk into the main body frame is formed; and
a rack loading member moved forward or backward within the main body frame, wherein
a convex portion formed on the opening member is inserted in a guide groove formed in the rack loading member,
the opening member is rotatably and pivotally supported by the main body frame,
in a disk reproducing state in which the disk is inserted in the main body frame, the rack loading member is moved backward, the convex portion inserted in the guide groove is slidably moved along the guide groove to follow a backward movement of the rack loading member, and the opening member rotated and inclined to follow a slidable movement of the convex portion is assembled in a front surface of the disk apparatus.

2. An electronic apparatus including the disk apparatus according to claim 1, comprising:
a display unit that displays an image based on output data output when information is reproduced from the disk.
